(19) United States
(12) Patent Application Publication
(10) Pub. No.: US 2010/0152928 A1
(43) Pub. Date: Jun. 17, 2010

(54) SYSTEM FOR SECURING THE DISPLAY OF INSTRUCTIONS ORIGINATING FROM AIR TRAFFIC CONTROL

(75) Inventors: Bruno Aymeric, St. Medard En Jalles (FR); Yannick Leroux, Le Haillan (FR); Pierre-Olivier Garros, Talence (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/639,690

(22) Filed: Dec. 16, 2009

(30) Foreign Application Priority Data
Dec. 16, 2008 (FR) 08 07057

(51) Int. Cl. G01C 23/00; G06F 3/01

(52) U.S. Cl. 701/3; 715/702

(57) ABSTRACT

The system for automatically registering flight instructions for aircraft comprises a flight computer delivering a first set of flight instructions defining a pre established flight plan, called CONS_FMS, the system comprising a display, the display representing the current flight instructions, the system comprising a device for controlling instructions which comprises means of adjusting a second set of flight instructions, called CONS_PILOTE, the system comprising a manager of instructions originating from air traffic control, the instructions being transmitted by means of a data link, said instructions defining a third set of instructions, called CONS_CONTROLEUR.

The system comprises:
means of viewing the third set of instructions;
means of confirming said instructions making it possible to display them on the display separately to the sides of the current flight instructions, and;
means of activating said instructions making it possible to replace the current instructions.

### PRIORITY CLAIM

This application claims priority to French Patent Application Number 08 07057, entitled System for Securing the Display of Instructions Originating From Air Traffic Control, filed Dec. 16, 2008.

### FIELD OF THE INVENTION

The present invention relates to the field of cockpit display and control systems for aircraft. More particularly, the invention relates to the complex display systems intended to display critical flight instructions, the latter possibly originating from different sources. Furthermore, the invention deals more particularly with the display of information requiring a high degree of integrity, and activation of said information for the navigation of an aircraft.

### BACKGROUND OF THE INVENTION

Currently, the display systems for aircraft comprise a number of windows, the composition of these windows depends on a number of parameters, notably the flight phase, the configuration required by the pilot and the updating of the data by the aeroplane systems.

Nevertheless, certain windows contain information of great importance to the conduct of the flight, called primary flight information. Such information requires a permanent display on the screen available to the pilot. This display configuration is called, to use the common aeronautical term: “Primary Flight Display”, abbreviated to PFD. The PFD generally comprises a number of display areas.

Among the areas that make up this PFD, there is the display of the flight modes that represents the state and engagement of the modes of the flight director, the thrust director, the automatic pilot and the auto-throttle.

This last display area is generally called FMA panel in which the acronym FMA stands for Flight Mode Annunciations.

The FMA panel therefore generally displays only status feedback from the flight director system. However, recent improvements to the FMA panel make it possible to also include a representation of the target of the modes that the automatic pilot is following. For example, in HEADING mode, the value of the heading serving as an instruction is displayed alongside the lateral mode indication.

The management of the automatic pilot is handled via a dedicated control panel, also called Flight Guidance and Control Panel, abbreviated FGCP. This panel can also be used to change a mode, or an instruction, such as the value of this heading.

Some of these panels include visual feedback on instruction values and sometimes also on modes and units.

Furthermore, many exchanges comprising flight instructions originate from the air traffic controllers. Most of the instructions are delivered orally by a radio channel but are more and more beginning to be transmitted, in the recent systems, by data links.\

Some window display systems make it possible to access and draft messages originating from or addressed to air traffic controllers.

Designation means incorporated in a management window enable the pilot to perform, via the selection of displayed interactive objects, the necessary actions.

With the messages being formatted, an avionic system can interpret these messages and register them. This solution exists with regard to the messages that have an impact on the flight computer, such as an FMS, FMS being an acronym standing for Flight Management System in aeronautical terminology. The message can thus be transmitted directly to the FMS, which will modify the flight plan accordingly subject to the control and confirmation of the pilot. Depending on the implementations, the interface of the FMS then makes it possible to check the modification of the flight plan and activate it.

On the other hand, a problem remains when the conduct of the flight is not handled by the FMS because there is as yet no automatic registration of the instructions originating from the air traffic controllers.

For example, if the aircraft is not in vertical navigation mode managed by the FMS, the vertical trajectory followed by the aircraft is not that recommended by the FMS but the one set manually by the pilot through the FGCP.

The proliferation of the displays and windows displaying the flight instructions constitutes a potential risk of incorrect interpretation and incorrect manipulation.

The flight instructions can, depending on the modes, originate from the FMS or to be set manually from a control device or be received from air traffic control via data links. Furthermore, the pilot needs to be able to rapidly discriminate a value of a current instruction and a selected instruction ready to be sent to the flight computer.

The equipment to be supervised by the pilot, the navigation modes and the various states of the flight instructions multiply the interpretation risks on the part of the pilot.

### SUMMARY OF THE INVENTION

The invention makes it possible to overcome the abovementioned drawbacks.

Notably, the invention makes it possible to concentrate a clear and distinct display, in the FMA for example, of the different instruction values, of their origin and of their state while retaining safety regarding the activation of the instructions for them to be registered by the flight computer.

The display device according to the invention makes it possible to represent the instructions input by the pilot to the FGCP, to allow the commands from air traffic control to be recovered automatically via the management interface and to make use thereof to modify the preselected instructions on the display device.

Furthermore, the control device according to the invention makes it possible to select instructions originating from the FMS or manual instructions and simply discriminate them.

The display device then enables the pilot to check, always in the same area in the screen, that the commands from air traffic control are correctly entered and confirm them so that they become actual instructions for the automatic pilot.

Advantageously, the system for automatically registering flight instructions for aircraft comprises:
an automatic pilot and a display device, the display device comprising a determined area grouping together the display of the current flight instructions;
a flight computer delivering a first set of flight instructions defining a pre-established flight plan, called CONS_FMS;
a device for controlling a second set of manual flight instructions, called CONS_PILOTE;
a manager of instructions originating from air traffic control, said instructions being transmitted by means of a data link via microwave channels and defining a third set of instructions, called CONS_CONTROLEUR,
means of viewing the third set of instructions.

Advantageously, the system comprises:
means of selecting at least one instruction, called selected instruction, from at least one of the sets of instructions making it possible to display at least its value in the distinctly determined area to the sides of the current flight instructions, the distinction being made by means of a first noteworthy symbol system and;
means of activating at least one selected instruction making it possible to replace the current instruction with the value of the selected instruction in the determined area, each activated selected instruction being transmitted to the flight computer.

Advantageously, in one embodiment, the means of activating an instruction from the first and from the second sets are identical. In another embodiment that can be combined with the preceding one, the means of activating an instruction from the third and from the second sets are identical.

Advantageously, the control device comprises the means of activating an instruction from the second set.

Advantageously, the control device comprises the means of selecting an instruction from the first and from the second sets.

Advantageously, the means of selecting an instruction from the second set comprise means of adjusting a numerical value.

Advantageously, the means of selecting an instruction from the first set comprise a mode selection button.

Advantageously, the adjustment means make it possible to modify a value of a selected instruction, the display device comprising a second noteworthy symbol system corresponding to a “modification in progress” state of a selected instruction.

Advantageously, the adjustment means comprise at least one selector switch.

Advantageously, the means of selecting an instruction from the third set is a button located on the air traffic control instruction manager.

Advantageously, the means of activating an instruction from the third set is a tactile button positioned superimposed on the viewing means.

Advantageously, the means of activating an instruction from the third set is a tactile button positioned superimposed on the display device.

Advantageously, an instruction comprises at least one of the following instructions: speed, altitude, heading or vertical angle of the aircraft with the horizon.

Advantageously, the control device comprises at least one selector switch for each of the flight instructions.

Advantageously, a rotation of a selector switch makes it possible to adjust the displayed value of an instruction from the second set and a pressure can be used to activate the value of the selected instruction as the current instruction to be processed by the flight computer.

### BRIEF DESCRIPTION OF THE DRAWINGS

Other characteristics and advantages of the invention will become apparent from the following description, given in light of the appended drawings that represent:

FIG. 1A: a device for controlling flight instructions;

FIG. 1B: a device for displaying and selecting flight instructions originating from air traffic control;

FIG. 2: a device for displaying flight instructions when they are entered by a pilot;

FIG. 3: a device for displaying flight instructions when one of them is in the process of being modified;

FIG. 4: a device for displaying flight instructions when at least one of them is activated;

FIG. 5: a device for displaying flight instructions comprising means of activating the flight instructions from air traffic control.

### DETAILED DESCRIPTION OF PREFERRED EMBODIMENT

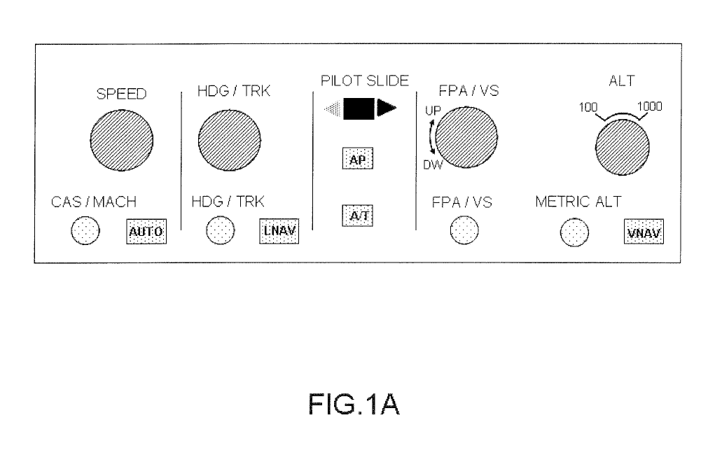

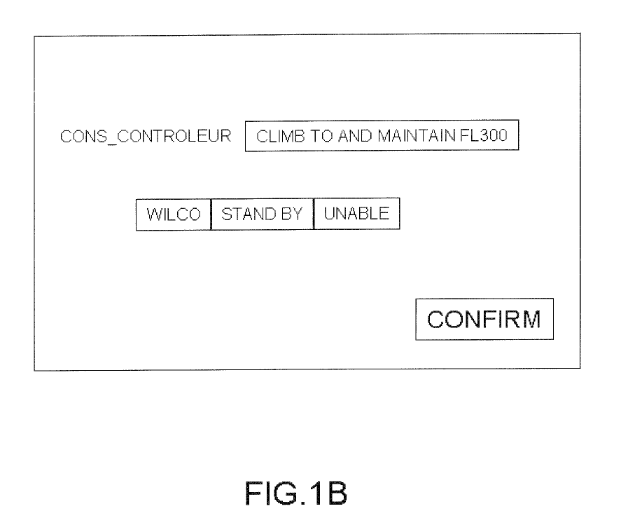

FIG. 1 represents a device for controlling a first set of instructions, called flight instructions. This control device is essentially dedicated to setting manual instructions adjusted by the pilot.

In a preferred embodiment, a manager of instructions from air traffic control is separate from the control device, but can also, in another embodiment, be incorporated in this same device. Furthermore, some functions relating to the instructions originating from air traffic control can be supported by the control device, such as the modification of instruction or activation.

Initially, the main functions of the control device are detailed.

A first part of the control device is intended for the management of the speed of the aircraft.

A first SPEED selector switch makes it possible to set the speed and a first CAS/MACH button makes it possible to define the unit of the speed that is to be set and displayed by means of the display device, the latter being able to be expressed in knots or in mach terms.

A press on the first selector switch makes it possible to activate the value so that it can be registered by onboard computer.

When an instruction value appears on the display device following manipulation of the selector switch, the first value displayed is the current value of the parameter. For example, if the aircraft has a speed of 250 knots, the first value displayed will be 250 knots, then this value will change according to the actions of the pilot on the selector switch.

A second AUTO button enables the pilot to choose the source of the instruction speed, the instruction possibly originating either from the flight computer, also called FMS, FMS standing for Flight Management System, or from a manual command entered by the pilot from a control device.

In manual mode, it is via the selector switch that the instruction speed is modified by the pilot himself. In automatic pilot mode, the speed instruction is supplied by the FMS (Flight Management System).

In AUTO mode, it is the speed calculated by the FMS that is selected and displayed on the display device alongside the current value. When the pilot presses on the selector switch, the instruction of the flight plan originating from the FMS is registered by the auto-throttle. It is also this speed that is displayed on the display device instead of the current value.

In a variant embodiment or in an appropriate flight mode, the selector switch can be used to adjust the thrust, and in the latter case the display no longer indicates SPEED but THRUST for example, indicating that it is a thrust instruction.

A second part of the control device is intended for the lateral navigation of the aircraft.

A second HDG/TRK selector switch of this first part can be used to adjust the heading and display it by means of the display device. The heading can be expressed by a heading in degrees relative to the direction of the nose of the aircraft or relative to the trajectory of the aircraft.

A third HDG/TRK button can be used to choose the nature of the heading entered in manual mode. A press on the second button engages the HDG or TRK mode.

The HDG mode indicates that the heading is calculated relative to the direction of the nose of the aircraft.

The TRK mode means that the heading is calculated relative to the trajectory of the aircraft.

A press on the second selector switch can be used to activate the value for it to be registered by the onboard computer.

When an instruction value appears on the display device following the manipulation of the selector switch, the first value displayed is the current value of the parameter.

A fourth LNAV button enables the pilot to choose the source of the instruction, the instruction possibly originating either from the FMS, or from a manual command input by the pilot from the second selector switch of the control device.

When the fourth LNAV button is engaged, the “lateral navigation” mode of the FMS is selected, which means that the lateral navigation is ready to be automatically managed by the FMS.

In the latter case, the instruction of the flight plan originating from the FMS is displayed alongside the current value.

The automatic lateral navigation is activated by a press on the HDG/TRK selector switch.

The instructions originating from the FMS are then directly registered by the automatic pilot. The values of the instructions displayed on the display device are those originating from the FMS.

Generally, the heading is then determined by a defined point in space such as a waypoint that is to be reached. A waypoint is a known point in space used to define a point of passage of the aircraft in a flight plan.

A third part of the control device is intended for the vertical navigation of the aircraft.

A third FPA/VS selector switch can be used to set the level of the vertical speed or of the angle of inclination with the horizon.

A press on the third selector switch can be used to activate the value for it to be registered by the onboard computer.

A fifth FPA/VS button can be used to choose the parameter that is to be set between the vertical speed and the angle of inclination with the horizon. A press on the fifth FPA/VS button engages the corresponding vertical mode.

Since the altitude of the aircraft is a particularly critical parameter, the instruction entered manually by the pilot is compared with an altitude instruction. For example, if the pilot chooses a positive VS value, the selected altitude must be greater than the current altitude.

A fourth ALT selector switch can be used to define an instruction altitude to be reached by the aircraft.

A press on the fourth selector switch can be used to activate the value for it to be registered by the onboard computer.

A sixth METRIC ALT button can be used to choose the unit of the altitude for the setting and display of the latter. Generally, it can be displayed in meters or in feet.

A seventh VNAV button enables the pilot to choose the source of the instruction, the instruction possibly originating from the FMS, or from a manual command entered by the pilot from a control device.

When the seventh VNAV button is engaged, the “vertical navigation” mode of the FMS is selected, which means that vertical navigation is ready to be automatically managed by the FMS.

In the latter case, the instruction of the flight plan originating from the FMS is displayed alongside the current value.

The automatic vertical navigation is activated by a press on the FPA/VS selector switch.

The instructions originating from the FMS are then directly registered by the automatic pilot. The values of the instructions displayed on the display device are those originating from the FMS.

Finally, a last part of the control device makes it possible to activate the autopilot or the auto-throttle.

The autopilot, denoted AP, being the automatic piloting of the flight director and the auto-throttle, denoted A/T, being the automatic piloting of the thrust director, these buttons can be used to engage the desired navigation mode.

The invention makes it possible to display on the display device a number of states of the flight instructions. The flight instructions can be:
in the “selected” state, when they have just been adjusted by means of the control device, notably by a selector switch, or in the “confirmed” state when they originate from the manager of instructions from air traffic control and they have just been confirmed by the pilot;
in the “modified” state, when they are currently being modified by the pilot;
in the activated state, when they are activated by the pilot so that the aircraft follows the instructions.

Advantageously, the display device according to the invention can be a part of the FMA.

The invention advantageously makes it possible to display on the display device an instruction selected by the pilot and not activated alongside the current or activated instruction.

The system according to the invention comprises a manager of instructions from air traffic control.

FIG. 1B represents a simplified interface of the manager of instructions from air traffic control.

An instruction indicator, denoted CONS_CONTROLEUR, can be used to display the last instruction received by the aircraft originating from air traffic control. The reception is via microwave or satellite channel by a data link. In the example, the instruction received is, for example, designated by “CLIMB TO AND MAINTAIN FL300”, which means that the aircraft must climb and maintain the flight level at the altitude FL300.

On receipt of an instruction by air traffic control, the pilot can:
reject the instruction from air traffic control by an UNABLE button;
place the instruction on standby and confirm it or reject it subsequently using a STAND BY button
accept and confirm the command using a WILCO button.

In the latter case, the instruction that is confirmed by means of the WILCO button is displayed on the display device.

The activation for safety measures is handled by the pilot in a second time for example using a CONFIRM button.

Other embodiments make it possible to activate the value by the control device or the display device.

When the confirmed instruction is activated, it becomes the current instruction value of the flight director. The old current value displayed disappears and is replaced by the new value thus activated. Furthermore, the parameter of the instruction will be delivered to the flight computer to be registered by the navigation equipment.

The first button is then superimposed on the interface of the management of instructions from air traffic control.

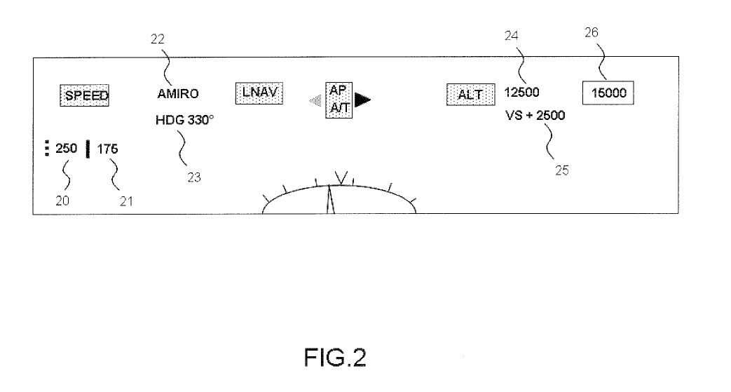

FIG. 2 represents a device for displaying the first set of instructions according to the invention.

A first mode, called longitudinal mode, indicates the speed of the aircraft. A speed indicator SPEED is used to display on the one hand the current longitudinal speed 21 supplied by the FMS, or 175 knots in the example of the figure, and on the other hand the selected speed instruction 20 alongside the current value of 250 knots. The current value of the speed and the speed instruction can be represented for example by two different colours so as to simply differentiate them.

When the pilot wants to, he can activate the speed instruction in place of the current speed value via pressure on the first selector switch.

The invention makes it possible to display, alongside the instruction values, a symbol indicating whether the instruction is a manual instruction or an instruction originating from the FMS

For example, in FIG. 2, the dots alongside the selected speed instruction indicate that it is a manual instruction. On the other hand, the solid line alongside the current value indicates that it is an instruction originating from the FMS. Another representation can be used to indicate that the origin of the instruction is air traffic control.

Advantageously, this makes it possible to rapidly indicate to the pilot the origin of the speed instruction.

Moreover, a second mode, called lateral mode, can be used to display the current heading value by means of the display device according to the invention. The heading can be either a waypoint to be reached, thus designating a relative heading relating to the current position of the aircraft, or a heading of which the value is expressed in degrees either relative to its flight direction, or relative to the axis of the aircraft depending on whether the HDG or TRK mode is engaged.

In the example of FIG. 2, the current heading 22 is designated by the nomination of a waypoint AMIRO, so this instruction therefore originates from the FMS. On the other hand, the heading 23 selected by the pilot by means of the control device, notably via the associated selected switch, is designated by a heading value of 330° expressed in degrees. The heading selection mode, HDG or TRK, is indicated alongside the displayed value.

In one embodiment, the LNAV indicator clearly tells the pilot whether the current or active instruction is an instruction from the FMS.

Finally, a third mode can be used to display the value of the altitude and the vertical navigation instructions.

An indicator makes it possible to know the nature of the current instruction. Depending on the nature of the current instruction, for example an altitude, a vertical speed or an angle of inclination, the indicator displayed is ALT, VS or FPA.

The value of the current altitude 24 indicates, in the example, 12 500 feet. The selected value designating the altitude instruction 26 by the pilot from the altitude setting selector switch is 15 000 feet. In the example of FIG. 2, this value 26 is displayed alongside the current value. The value of the selected instruction can be represented so as to easily discriminate the current value from the selected value either by a different colour or by a geometrical shape associated with the value, such as a rectangular frame represented in FIG. 2.

The display device according to the invention makes it possible to display the selected vertical speed value 25, the value of which in the example is 2500 feet/minute.

The display device according to the invention can be used to display an indicator depending on the nature of the current instruction. This indicator can be ALT to designate an altitude, VS to designate a vertical speed or else FPA to designate an angle of inclination of the aircraft.

As long as the altitude instruction 26 is not activated, it remains alongside the current value.

The value of the instruction 25 gives a vertical speed indication to reach the altitude instruction 26.

The altitude instruction 26 is set from the fourth ALT selector switch on the control device.

The selected altitude 26 becomes active when the pilot presses the fourth selector switch.

Finally, a last part of the display device can be used to display two indicators, AP, designating the autopilot, and A/T, designating the auto-throttle.

Autopilot being the autopiloting of the flight director and auto-throttle being the automatic piloting of the thrust director, these indicators make it possible to know the navigation mode used.

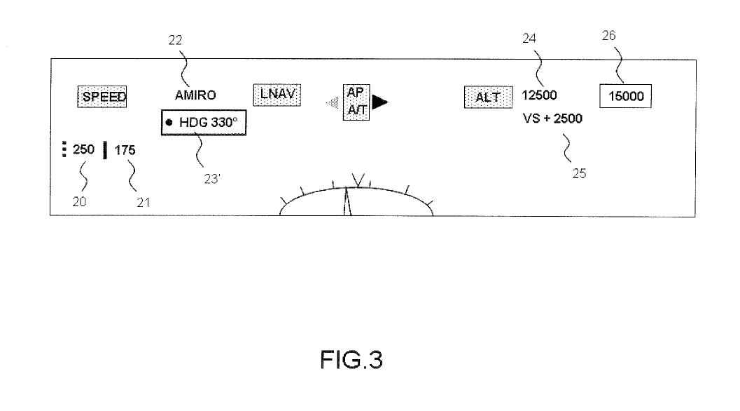

FIG. 3 represents the display device according to the invention when a parameter of an instruction originates from the manager of messages from air traffic control and it has been confirmed by the pilot, for example using the interface of the instruction manager.

The display device according to the invention displays an instruction 23′ indicating HDG 330°. The display of the instruction follows the receipt of a message from air traffic control by data links requesting the crew to follow the heading 330°.

The instruction confirmed in this way by the pilot is awaiting activation. The confirmed instruction is therefore displayed alongside the current value 22 here represented by a waypoint name, in the example AMIRO.

The other instructions of FIG. 3 remain unchanged compared to those of FIG. 2.

The pilot who has selected the value of the instruction from air traffic control received from the interface of the instruction manager has then accepted the message from the controllers.

Because of this, a HEADING instruction received from air traffic control that cannot be dealt with by a modification of the flight plan of the FMS, is transmitted to the display device pending possible subsequent activation.

One advantage is to be able to differentiate, on the display device according to the invention, an instruction originating from the FMS, an instruction set manually by the pilot and an instruction received via air traffic control.

The instruction received via air traffic control is therefore displayed differently alongside the current instruction on the display device.

A dedicated symbol system can be used to distinguish a current instruction from a selected instruction by a colour code or a distinctive sign.

Furthermore, the invention makes it possible to distinguish an instruction selected manually from the control device and a selected instruction originating from the manager of instructions from air traffic control.

The distinction is made, for example, by means of a dot or a geometrical shape indicating that the instruction has been confirmed by the manager of instructions from air traffic control.

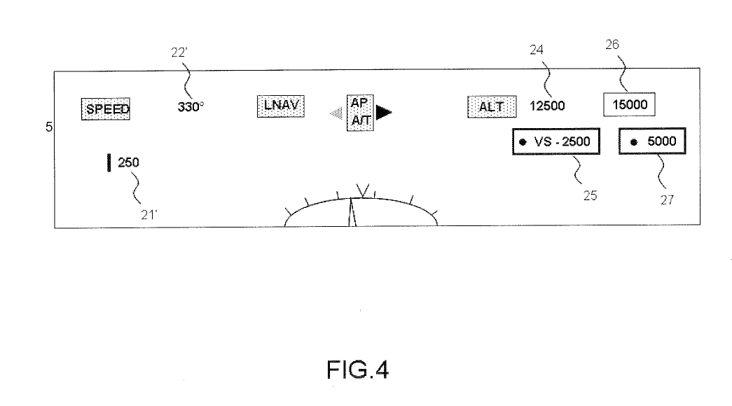

FIG. 4 represents another example display according to the invention. The instructions 25, 27 relating to the altitude comprised a target altitude of 5000 feet and a descent speed of 2500 knots. Advantageously, a geometrical shape, in the example a solid circle, located alongside the instructions selected by means of the interface of the instruction manager, make it possible to deduce the fact that the instructions originate from the manager of instructions from air traffic control.

In this example, the instruction from air traffic control relates to a change of altitude. The instruction altitude value is proposed, as is a vertical speed value fur teaching this altitude. In an alternative, depending on the selection on the part of the pilot, the descent speed instruction can be an angle of inclination value.

In this example, the instruction 22′ has been activated by a pressure on the selector switch corresponding to the control device and the instruction 21′ has also been activated by a pressure on the corresponding selector switch of the control device. The latter two instructions are then current navigation instructions that have been transmitted, following activation, to the flight computer to be registered by the navigation equipment.

In all the cases, the invention enables the pilot, from a secure interface, to confirm the instructions received initially for them to be displayed alongside the current instructions. Then, the registration by the automatic pilot will be triggered by a specific action aiming to activate the instructions.

This can be done according to different variant embodiments.

In a first variant embodiment represented in FIG. 1B, an interface of the manager of instructions from air traffic control, denoted CONS_CONTROLEUR, displays a first button, denoted CONFIRM. An action on the first button can be used to activate the instruction, designated by “CLIMB TO AND MAINTAIN FL300” in the example of the figure.

In the latter case, the instruction that was previously selected by means of the WILCO button and displayed on the display device according to the invention will become the current value. The old current value displayed will disappear and will be replaced by the duly activated new value. Furthermore, the parameter of the instruction will be delivered to the flight computer to be registered by the navigation equipment.

The first button is then superimposed on the interface of the manager of instructions from air traffic control.

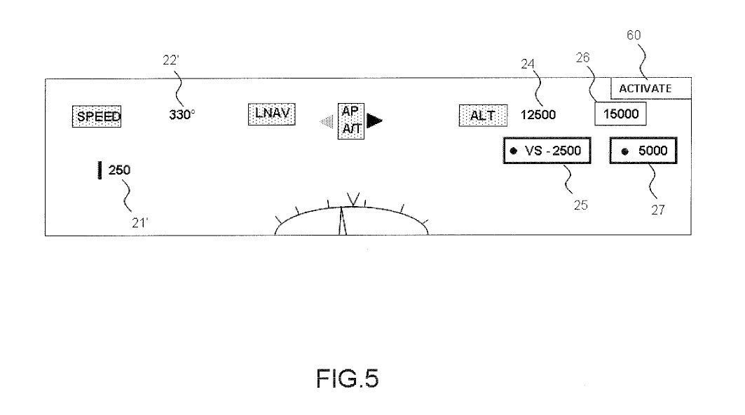

FIG. 5 represents a second variant embodiment, in which the activation of the instruction is performed by means of a tactile pressure on the display device in an area 60 indicating ACTIVATE.

The other instructions remain unchanged compared to FIG. 4.

In a third variant embodiment, the activation of the instruction originating from air traffic control is handled by means of a pressure on the selector switch of the control device corresponding to the instruction parameter. This latter case benefits from a common manipulation to activate a manual command and a command originating from the manager of commands from air traffic control.

In all the variant embodiments, the activation causes the old active instruction to be replaced in the display device according to the invention by the previously selected new instruction.

Furthermore, the invention makes it possible to indicate that a selected value is currently being modified. The instruction selected, manually for example, displayed alongside the current instruction can be modified at each instant by the pilot.

Depending on the variant embodiments, the value currently being modified can be represented by a different colour and/or surrounded by a geometrical shape such as a rectangle or even can be displayed in “reverse video” representation.

The invention makes it possible to attract the attention of the pilot to the value currently being modified. For example, while setting the vertical speed, the instruction indication switches to “reverse video” display mode.

Thus, the crew clearly sees which parameter is currently being modified, avoiding any misinterpretation and any incorrect manipulation.

The display device according to the invention makes it possible to ensure that an instruction value remains displayed. Thus, a pilot can prepare an instruction value that will be used later by engaging the corresponding mode.

The latter case is commonplace when the pilot knows that the air traffic controller will ask him, for example, to reduce speed. He can then be ready and act quickly in order to activate an instruction.

Furthermore, he can also use the WILCO button to confirm an instruction received via air traffic control in order to activate it later.

If the pilot commits an error by manipulating a selector switch, the value of the instruction associated with the selector switch may be erased.

Advantageously, the pilot can change the erroneous value by pressing again on the button corresponding to the mode currently engaged. For example, if the pilot has carried out a wrong manoeuvre on a selector switch, such as the speed selector switch, by pressing on the AUTO button, he will cause the display of the manual instruction value to disappear from the display device.

1. System for automatically registering flight instructions for aircraft, the system comprising
an automatic pilot and a display device, the display device comprising a determined area grouping together the display of the current flight instructions;
a flight computer delivering a first set of flight instructions defining a pre-established flight plan, called CONS_FMS;
a device for controlling a second set of manual flight instructions, called CONS_PILOTE;
a manager of instructions originating from air traffic control, said instructions being transmitted by means of a data link via microwave channels and defining a third set of instructions, called CONS_CONTROLEUR,
means of viewing the third set of instructions,
wherein the system comprises:
means of selecting at least one instruction, called selected instruction, from at least one of the sets of instructions making it possible to display at least its value in the distinctly determined area to the sides of the current flight instructions, the distinction being made by means of a first noteworthy symbol system and;
means of activating at least one selected instruction making it possible to replace the current instruction with the value of the selected instruction in the determined area, each activated selected instruction being transmitted to the flight computer and;
in that the control device comprises means of activating an instruction from the second set and means of selecting an instruction from the first and the second sets, the means of selecting an instruction from the second set comprising means of adjusting a numerical value, the adjustment means making it possible to modify a value of a selected instruction, the display device comprising a second noteworthy symbol system corresponding to a “modification in progress” state of a selected instruction.

2. System for automatically registering flight instructions according to claim 1, wherein the means of activating an instruction from the first and the second sets are identical.

3. System for automatically registering flight instructions according to claim 1, wherein the means of activating an instruction from the third and the second sets are identical.

4. System for automatically registering flight instructions according to claim 1, wherein the means of selecting an instruction from the first set comprise a mode selection button.

5. System for securing the display of flight instructions according to claim 1, wherein the adjustment means comprise at least one selector switch.

6. System for automatically registering flight instructions according to claim 1, wherein the means of selecting an instruction from the third set is a button located on the air traffic control instruction manager.

7. System for automatically registering flight instructions according to claim 1, wherein the means of activating an instruction from the third set is a tactile button arranged superimposed on the viewing means.

8. System for automatically registering flight instructions according to claim 1, wherein the means of activating an instruction from the third set is a tactile button arranged superimposed on the display device.

9. System for automatically registering flight instructions according to claim 1, wherein an instruction comprises at least one of the following instructions: speed, altitude, heading or vertical angle of the aircraft with the horizon.

10. System for automatically registering flight instructions according to claim 4, wherein the control device comprises at least one selector switch for each of the flight instructions.

11. System for automatically registering flight instructions according to claim 10, wherein a rotation of a selector switch makes it possible to adjust the displayed value of an instruction from the second set and that a pressure makes it possible to activate the value of the selected instruction as the current instruction to be processed by the flight computer.
